(19) United States
(12) Patent Application Publication
(10) Pub. No.: US 2005/0007897 A1
(43) Pub. Date: Jan. 13, 2005

(54) Optical disk device

(75) Inventors: Masanori Soda, Chikushino-shi (JP); Hirohisa Koizumi, Tamana-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/885,576

(22) Filed: Jul. 8, 2004

(30) Foreign Application Priority Data
Jul. 9, 2003 (JP) 2003-194213
Jun. 15, 2004 (JP) 2004-176828

(51) Int. Cl. G11B 7/085

(52) U.S. Cl. 369/30.26

(57) ABSTRACT

An optical disc device according to the present invention includes a first circuit part, a holding part which mounts an optical pickup capable of performing either one of recording of data and reproducing of data with respect to an optical disc; and a second circuit part which is provided to the holding part, wherein a distance between the first circuit part and the second circuit part is changeable and, when the distance between the first circuit part and the second circuit part assumes a value equal to or below a given distance, the transmission of signals containing at least analogue signals having frequency of 11 MHz or more or digital signals having a signal transmission rate of 20 Mbps or more is allowed and when the distance between the first circuit part and the second circuit part assumes a value above the given distance, the transmission of the signals is interrupted.

### BACKGROUND OF THE INVENTION

1. Field of the Invention

The present invention relates to an optical disc device which is mounted on or connected to an electronic equipment.

2. Description of the related art

As an optical disc mounting method of an optical disc device such as a CD-ROM/R/RW or a DVD-ROM/RAM/R/RW which is mounted on an electronic equipment, a method in which a tray is pulled out from a housing, an optical disc is mounted on the tray and the optical disc is again mounted by returning the tray into the housing (hereinafter referred to as “a tray method”) has been generally used. Hereinafter, the explanation is made with respect to the constitution of a conventional tray-method optical disc device in conjunction with drawings.

FIG. 6 is an appearance view of a conventional tray-method optical disc device and FIG. 7 is also an appearance view of the conventional tray-method optical disc device in a state that a ceiling portion 2a is removed. The optical disc device 1 includes a housing 2 and a tray 3, wherein FIG. 6 and FIG. 7 show a state that the tray 3 is pulled out from the housing 2. The housing 2 is constituted of the ceiling portion 2a and a bottom portion 2b. The tray 3 is provided with a pickup module 4. The pickup module 4 is formed of an optical pickup 5 which constitutes an optical system, a spindle motor 4a which rotates an optical disc and a printed circuit board 4c which constitutes a control circuit. The spindle motor 4a includes an optical disc mounting portion 4b, wherein the optical disc is rotatably driven after being mounted on the optical disc mounting portion 4b. Rail portions 6 are formed on both side portions of the tray 3 and both side portions are slidably fitted into rails 7 in the optical-disc pull-out direction. Further, the rails 7 are slidably fitted into rail guides 8 which are provided to inner surfaces of both sides of the housing 2 in the optical-disc pull-out direction, whereby the tray 3 can be pulled out from the housing 2 while allowing the mounting and dismounting of the optical disc.

A printed circuit board 9 which constitutes a control circuit is formed on the bottom portion 2b of the housing 2. A connector 9a which is served for supplying an electric power and for inputting and outputting signals from outside is connected to the printed circuit board 9. The printed circuit board 9 and the printed circuit board 4c which is formed on the tray 3 are connected with each other using a flexible printed cable 10. The flexible printed cable 10 has an approximately U shape, wherein one arm thereof is folded back and is connected with the printed circuit board 4c. The fold-back portion 10a is moved in parallel in the take-in-and-out direction of the tray 3 along with a take-in operation and a take-out operation of the tray 3. Accordingly, the flexible printed cable 10 can maintain a wire connection state without colliding with other members of the optical disc device 1 even in a state that the tray 3 is housed in the casing 2 or even in a state that the tray 3 is pulled out at maximum.

As the prior art, techniques disclosed in Japanese Unexamined Publication Hei8(1996)-221967, Japanese Unexamined Publication Hei9(1997)-17113 and the like are named.

However, the printed circuit board 9 having the above-mentioned conventional is provided with the connector 9a which performs the supply of the electric power from the outside and the inputting and outputting of signals and hence, it is necessary to arrange the printed circuit board 9 at an end opposite to a side of the housing 2 in the pullout direction thereof. Further, the flexible printed cable 10 is formed in an approximately U shape to prevent the collision with other parts and hence, it is unavoidable that a length of a wiring pattern on the flexible printed cable 10 is elongated. On the other hand, a transfer rate of data which is written out and read from the optical disc device 1 has been steadily increased year by year. For example, with respect to a compact disc (CD), although the data transfer rate is approximately 4 Mbps at a standard speed (same fold), the data transfer rate is rapidly increased to 16 fold and 24 fold. Further, with respect to a DVD, although the data transfer rate is approximately 26.1 Mbps at a standard speed (same fold), the data transfer rate is also rapidly increased. With respect to the DVD which uses a blue semiconductor laser, it is expected that the data transfer rate is further rapidly increased.

Along with such rapid increase of the data transfer rate, the deterioration of signals attributed to an elongated flexible printed cable and noises which the elongated flexible printed cable collects give rise to drawbacks which cannot be ignored and a signal transmission part which replaces the flexible printed cable and exhibits the small deterioration of signals and hardly collects noises is requested.

### SUMMARY OF THE INVENTION

To overcome such drawbacks, the present invention provides an optical disc device which includes a first circuit part, a holding part which mounts an optical pickup capable of performing at least one of recording or reproduction of data with respect to an optical disc and a second circuit part which is provided to the holding part, wherein a distance between the first circuit part and the second circuit part can be changed, wherein the improvement is characterized in that when the distance between the first circuit part and the second circuit part is equal to or less than a given distance, signals which contain at least one of analogue signals having frequency of 11 MHz or more or digital signals having signal transfer rate of 20 Mbps or more can be transferred, while when the first circuit part and the second circuit part are spaced apart from each other more than the given distance, the signals are not transmitted.

### BRIEF DESCRIPTION OF THE DRAWINGS

FIG. 1 is an appearance view of an optical disc device according to one embodiment of the present invention;

FIG. 2 is an appearance view of the optical disc device according to one embodiment of the present invention in a state that a ceiling portion of housing is removed;

FIG. 3 is a block diagram of a main signal system of the optical disc device according to one embodiment of the present invention;

FIG. 4 is an appearance view of the optical disc device according to another embodiment of the present invention in a state that a ceiling portion of a housing is removed;

FIG. 5 is a block diagram of a main signal system of the optical disc device according to another embodiment of the present invention;

FIG. 6 is an appearance view of a conventional tray-method optical disc device; and

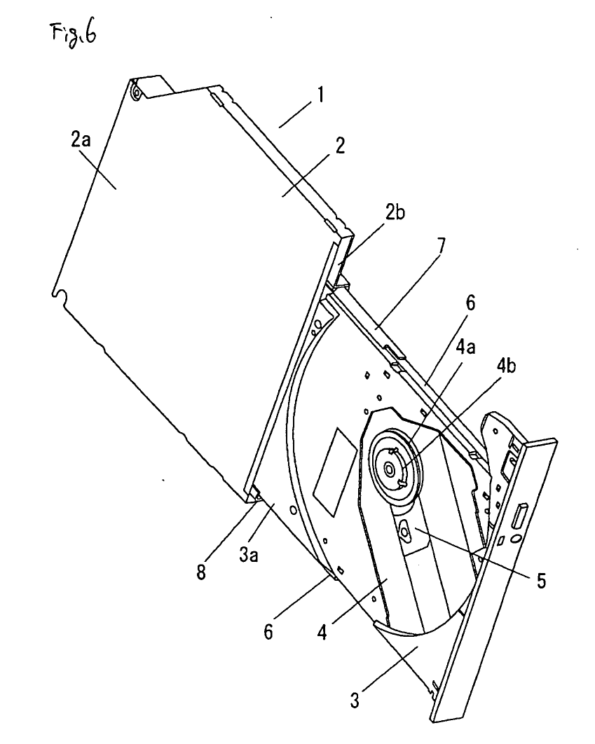

FIG. 7 is an appearance view of the conventional tray-method optical disc device in a state that a ceiling portion is removed.

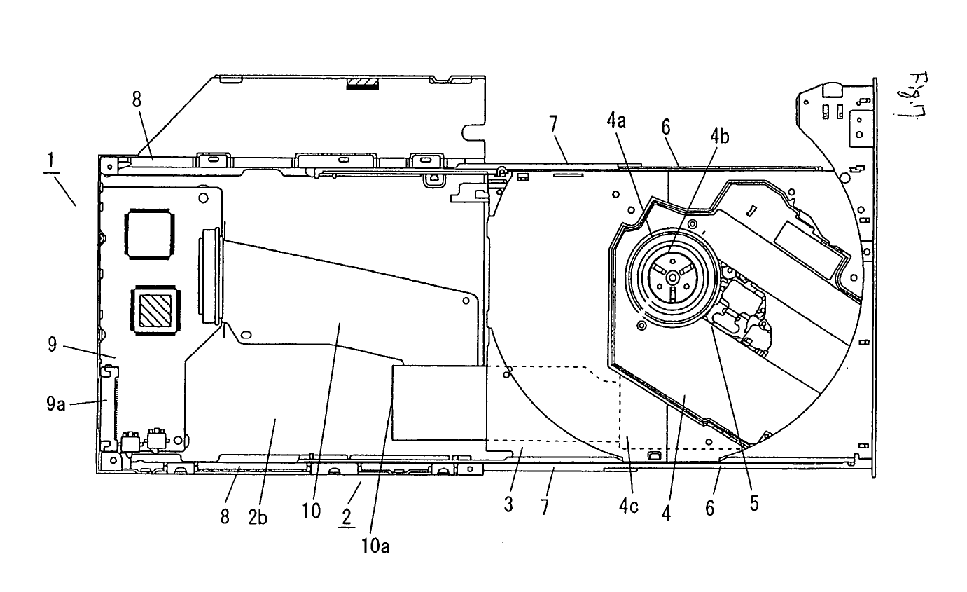

### DETAILED DESCRIPTION OF THE INVENTION

Preferred embodiments of the present invention are explained hereinafter in conjunction with attached drawings.

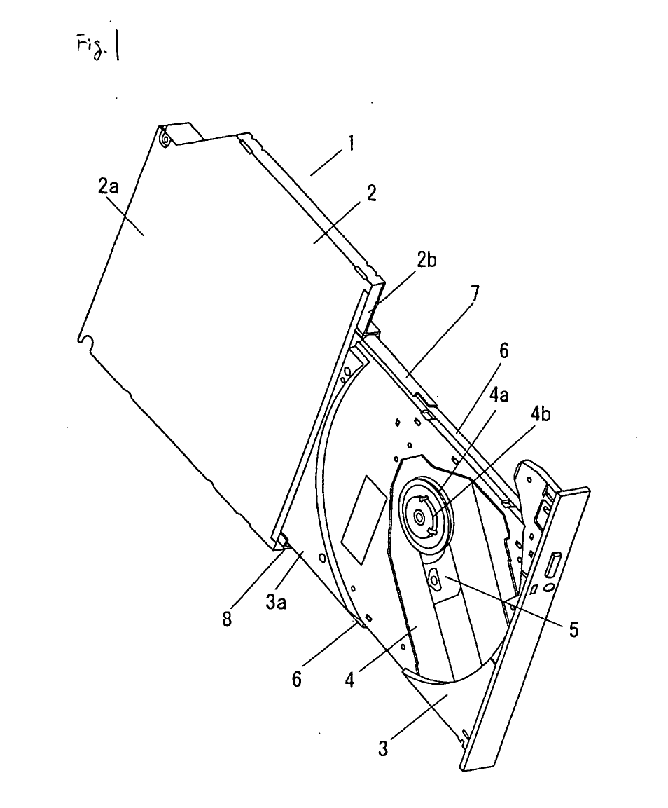

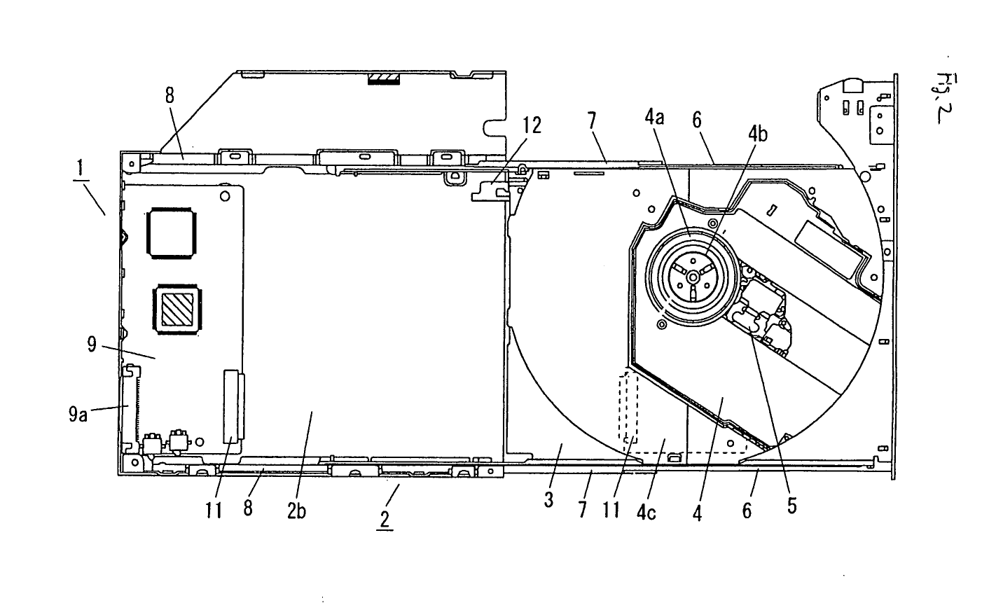

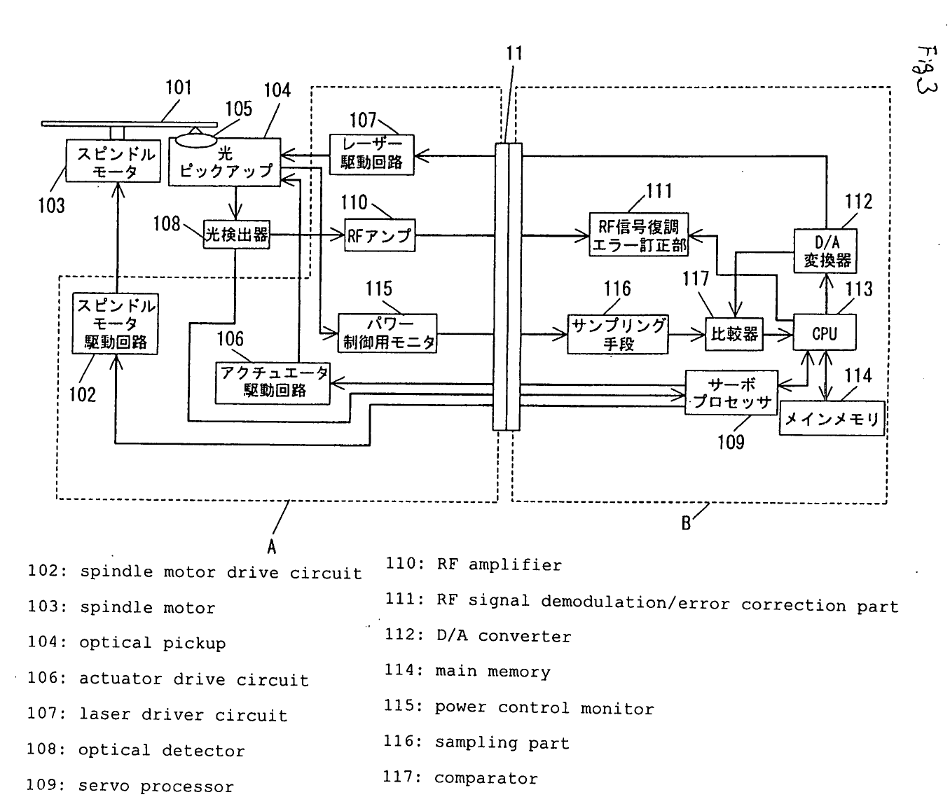

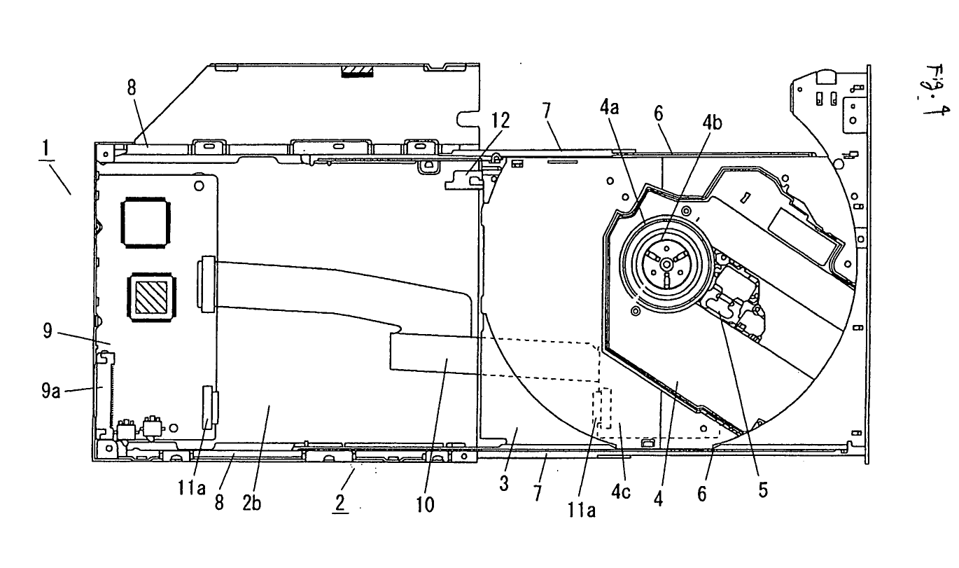

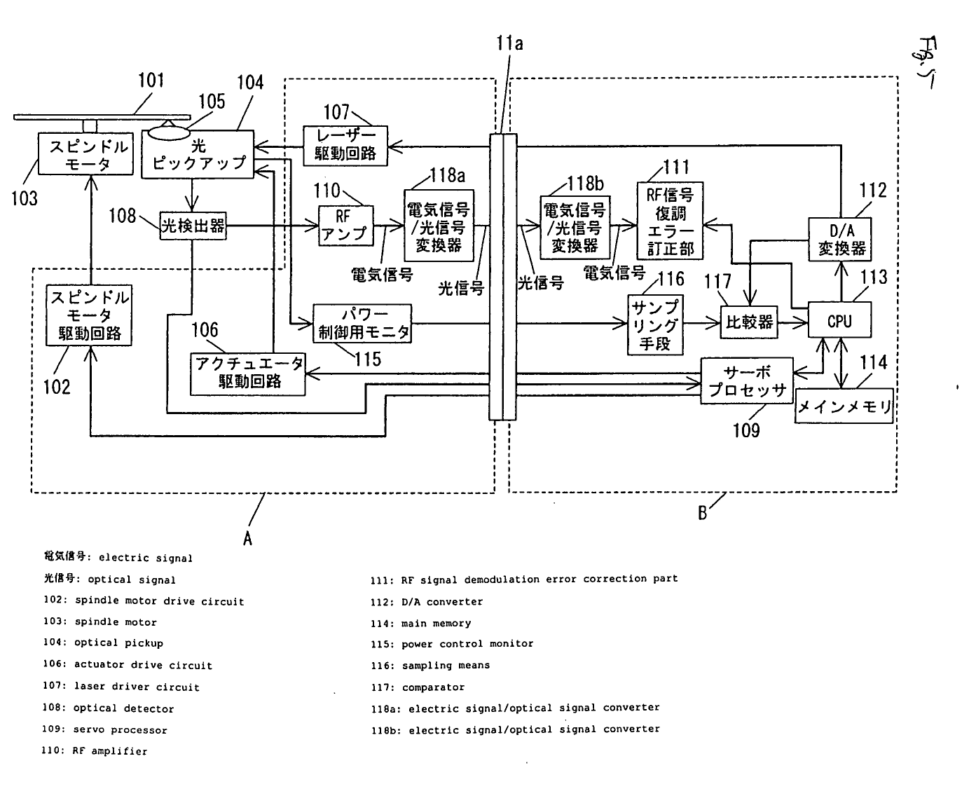

FIG. 1 is an appearance view of an optical disc device according to one embodiment of the present invention, FIG. 2 is an appearance view of the optical disc device according to one embodiment of the present invention in a state that a ceiling portion of a housing is removed, FIG. 3 is a block diagram of a main signal system of the optical disc device according to one embodiment of the present invention, FIG. 4 is an appearance view of the optical disc device according to another embodiment of the present invention in a state that a ceiling portion of a housing is removed, and FIG. 5 is a block diagram of a main signal system of the optical disc device according to another embodiment of the present invention.

The optical disc device 1 includes a housing 2 and a tray 3 and FIG. 1, FIG. 2 and FIG. 4 show a state in which the tray 3 is pulled out from the housing 2. The housing 2 is constituted of a ceiling portion 2a and a bottom portion 2b. The tray 3 is provided with a pickup module 4. The pickup module 4 is constituted of an optical pickup 5 which forms an optical system, a spindle motor 4a which rotates an optical disc and a printed circuit board 4c which forms a control circuit. The optical pickup 5 provided to the pickup module 4 approaches to or is retracted from the spindle motor 4a. The spindle motor 4a includes an optical disc mounting portion 4b and the optical disc is rotatably driven after being mounted on the optical disc mounting portion 4b. Rail portions 6 are provided to both side portions of the tray 3 and the rail portions 6 are slidably fitted into rails 7 in the optical-disc pullout direction together with both side portions. Further, the rails 7 are also slidably fitted into rail guides 8 in the optical-disc pull-out direction and hence, the tray 3 can be inserted into and is taken out from the housing 2. When the tray 3 is pulled out from the housing 2 by a given length, the tray 3 is stopped with respect to the housing 2. Here, it is possible to mount the optical disc onto or to remove the optical disc from the optical disc mounting portion 4b formed on the tray 3. The tray 3 is provided with a biasing portion 12 and hence, by allowing the biasing portion 12 to push the housing 2 at the time of performing an ejection operation, the tray 3 is ejected from the housing 2.

The optical disc device 1 is of a high-speed type for a CD-ROM, CD-R/RW or of a type which exhibits a high data transfer rate such as a DVD and exhibits the data transfer rate of 20 Mbps or more. A printed circuit board 9 which is provided with a control circuit is mounted on the bottom portion 2b of the housing 2, a printed circuit board 4c which includes a control circuit is provided to the tray 3, and a connector 9a which performs the supply of an electric power from the outside and inputting and the outputting of signals is connected to the printed circuit board 9.

A pair of connectors 11 is provided to the printed circuit board 9 and the printed circuit board 4c. One connector 11 is provided to the printed circuit board 9 and another connector 11 is provided to the printed circuit board 4c. The connectors 11 include terminals (not shown in the drawing) which are formed of a conductive material such as metal and, when the connectors 11 are connected, one terminal and another terminal of the connectors 11 are brought into contact with each other thus electrical conduction is obtained. When the connector 11 is separated, one terminal and another terminal assume a non-contact state from each other so that the electrical conduction is interrupted. The connectors 11 are positioned such that the connectors are connected with each other in a state that the tray 3 is housed in the housing 2 and the connectors 11 are separated from each other in a state that the tray 3 is pulled out from the housing 2, while when the connectors 11 are connected with each other, the transmission of signals and the electric power between the printed circuit board 9 and the printed circuit board 4c is performed, and the transmission of the signals and the electric power is not performed in the separated state. The maintenance of the connection state of the connectors 11 at the time of connecting is performed mainly by a lock mechanism (not shown in the drawing) of the tray 3 and the housing 2 at the time of housing the tray 3 in the housing 2 and hence, it is unnecessary for the connectors 11 to have a locking function. Further, an insertion/pulling force (a force necessary for inserting and pulling) of the connector 11 is set to a small value within a range which does not spoil the contact resistance of contacts (contacts become sufficiently electrically conductive with each other) and hence, there is no problem with respect to a point that the biasing portion 12 which pushes the tray 3 from the housing 2 at the time of performing an ejecting operation pushes the tray 3 against the insertion and pulling force of the connector 11.

As a power system, the supply of electric power to the spindle motor 4a and a feed motor (not shown in the drawing) which is provided to the pickup module 4 and drives the optical pickup 5 in the radial direction of the optical disc and the supply of electric power to a semiconductor laser (not shown in the drawing) provided to the optical pickup are named. On the other hand, as the signals, data signals which are read out from the optical disc and are written into the optical disc and signals which control the spindle motor 4a, the feed motor and the semiconductor laser are named.

The constitution of the signal system is explained in conjunction with FIG. 3. Numeral 101 indicates an optical disc to which the data is recorded and electric current is supplied to a spindle motor 103 from a spindle motor drive circuit 102 so as to drive the spindle motor 103. Numeral 104 indicates an optical pickup which performs at least one of recording and reproducing of data, numeral 105 indicates an object lens for laser focusing which is held by an actuator in the inside of the optical pickup 104 and is driven in the vertical direction and in the radial direction of the optical disc by an actuator drive circuit 106. An electric current is supplied to the optical pickup 104 from a laser drive circuit 107 so that the optical pickup 104 irradiates laser beams of given power to the optical disc 101. A reflection light from the optical disc 101 is received by the optical pickup 104, is converted into electric signals by a photo detector 108 and a servo error signals are detected by the optical detector 108. Here, the optical pickup 5 shown in FIG. 2 is constituted of the optical pickup 104 and the photo detector 108 shown in FIG. 3. The servo error signals are used as feed back signals of a servo processor 109 and the actuator drive circuit 106 and a spindle motor drive circuit 102 are controlled.

Further, the data stored in the optical disc 101 is converted into electric signals (referred to as RF signals) by the optical detector 108 and is amplified by an RF amplifier 110. The amplified RF signals are subjected to the demodulation into digital signals and error correction processing at an RF signal demodulation/error correction part 111 whereby the original digital signal which are data stored in the optical disc 101 are obtained.

To the laser drive circuit 107, a laser power determination voltage is supplied to determine a drive current of the laser using a D/A converter 112. Numeral 113 indicates a CPU for executing the logic determination and arithmetic operations. Numeral 114 indicates a main memory and is served as storage regions necessary for performing various recording controls and reproduction controls besides a storage region necessary for control. At the time of recording the data into the optical disc 101, the laser beams irradiated to the optical disc 101 are converted into voltages by a power control monitor 115 and voltages corresponding to the laser power are inputted to a comparator 117 through a sampling part 116. On the other hand, control values which correspond to the optimum recording laser power are stored in the main memory 114, wherein the control values are obtained from the main memory 114 by the CPU 113 and are inputted to the comparator 117 by the D/A converter 112. The comparator 117 compares a voltage value inputted from the sampling part 116 and a voltage value which is inputted from the D/A converter 112. The CPU 113, based on a result of the comparison, controls the laser drive circuit 107 such that the voltage value inputted to the comparator 117 from the sampling part 116 assumes the voltage value which is inputted to the comparator 117 from the D/A converter 112. A portion A in FIG. 3 is formed on the tray-3-side printed circuit board 4c and a portion B in FIG. 3 is formed on the housing-2-side printed circuit board 9 and the transmission of signals between these portions is performed via the connectors 11.

Here, FIG. 3 is a block diagram of a main signal system and the signal system may differ depending on a system. For example, there may be a case that an ejection signal system relevant to an ejection operation of the tray 3 is added to the system.

Here, since the optical disc device 1 has the data transfer rate of 20 Mbps or more, the signals which are transmitted via the connectors 11 also become high frequency signals, wherein the data transfer rate of the digital signal becomes 20 Mbps or more and the data transfer rate of the analogue signal becomes approximately 10 MHz or more. At least the terminal portions of the connectors 11 which transmit the signals are configured to cope with such high frequency signals. Further, at least the terminal portions of the connectors 11 which transmit the electric power are configured to cope with such the transmission of the electric power. Further, in a state that the connectors 11 are not connected each other, neither the electric power nor the signals are transmitted and hence, the connectors 11 function as switches which stop the emission of laser beams or the like at the time of pulling out the tray 3. Accordingly, it is unnecessary to provide a separate switch for stopping the emission of laser beams or the like. However, it may be possible to provide a switch which turns ON/OFF the emission of laser beams separately from the terminals of the connectors 11 such that the switch is turned on along with the connection of the connectors 11 and is turned off along with the separation of the connectors 11. Further, the system may be configured such that a relay circuit which turns ON/OFF the emission of laser beams is provided to the printed circuit board 4c, a control signal of the relay circuit is made to pass through the connectors 11, whether the connectors 11 are connected with each other or separated from each other is detected based on the conduction of the control signal, and the emission of laser beams is turned ON/OFF based on a detection result.

The connectors 11 are provided in plural (to be more exact, a plurality of pairs) and may be positioned that all of these connectors 11 are connected with each other in a state that the tray 3 is housed in the housing 2 and are separated from each other in a state that the tray 3 is pulled out from the housing 2. In this case, by providing the connectors 11 to the signal system and the electric power system individually, it is possible to provide the optimum constitution such that the optimum connectors which correspond more properly to frequency of signals can be selected as the connectors for the signal system, for example.

Further, by adding a switching function to stop a power source of the circuit before pulling out the tray 3 and to restore the power source of the circuit after mounting the tray 3 to the ejection operation of the optical disc, it may be possible to reduce erroneous operations of the circuit.

To prevent the printed circuit board 4c from assuming the electrically floating state in a state that the tray 3 is pulled out, it is effective to ground the printed circuit board 4c to the housing 2 through the rails 7 or to always connect only a ground line between the printed circuit board 4c and the printed circuit board 9 or between the printed circuit board 4c and the housing 2.

In this manner, by connecting the printed circuit board 9 and the printed circuit board 4c shown in FIG. 2 using the connectors 11, a transmission path of signals between the printed circuit board 9 and the printed circuit board 4c becomes short and hence, the signals to be transmitted hardly receive the influence of noises between the printed circuit board 9 and the printed circuit board 4c. Further, it is possible to suppress the occurrence of errors attributed to the deterioration of signals.

FIG. 4 shows an optical disc device in which, as the transmission part between the printed circuit board 9 and the printed circuit board 4c, a transmission part where the connection and the separation are performed in an interlocking manner with the housing of the tray 3 into the housing 2 or taking out of the tray 3 from the housing 2, and a transmission part which maintains the wire connection state of the printed circuit board 9 and the printed circuit board 4c irrespective of the housing of the tray 3 into the housing 2 and the taking out of the tray 3 from the housing 2 are used in combination. To be more specific, the signal system uses connectors 11a and the electric power system uses the flexible printed cable 10. In such a constitution, the connectors 11a are used only in the signal system where the deterioration of signals and the mixing of noises which have been considered drawbacks in the conventional constitution which uses only the flexible printed cable are liable to easily occur and hence, it is possible to overcome the above-mentioned conventional drawback and can miniaturize the connectors 11a. Since the miniaturization of the connectors 11a can be realized, the contact resistance of the contacts is ensured (the contacts can ensure the sufficient electric conduction). Further, the insertion and pulling-out force of the connectors 11a can be further decreased and hence, the setting of the biasing part 12 for pushing the tray 13 from the housing 2 at the time of ejection operation is facilitated. Here, with respect to the signals which hardly suffer from the deterioration thereof and the mixing of noises, the flexible printed cable 10 may be used. Also with respect to the ground system, the flexible printed cable 10 may be used.

Further, with respect to the signal system shown in FIG. 5, the connectors 11a are sandwiched between a part A (formed on the printed circuit board 4c) and a part B (formed on the printed circuit board 9), wherein the part A includes an electric signal/optical signal converter 118a and the part B includes an electric signal/optical signal converter 118b. Due to such a constitution, it is possible to perform the signal transmission using the optical signal at the connectors 11a. The connectors 11a are positioned such that the connectors 11a are connected with each other in a state in which the tray 3 shown in FIG. 4 is housed in the housing 2 and are separated from each other in a state that the tray 3 is pulled out from the housing 2. The connectors 11a are also served for positioning the transmission portions of the optical signals from both substrates and for performing the dust preventing function.

Each one of the electric signal/optical signal converter 118a and the electric signal/optical signal converter 118b includes a reception part and a transmission part of optical signals, wherein the electric signal/optical signal converter 118a is capable of converting the electric signals into the optical signals and transmitting the optical signals and the electric signal/optical signal converter 118b is capable of receiving the optical signal and coverting the optical signals into electric signals. When the electric signal/optical signal converter 118a in the part A (the printed circuit board 4c side) converts the electric signals into the optical signals and transmits the optical signals from the transmission part, the reception part of the electric signal/optical signal converter 118b in the part B (the printed circuit board 9 side) receives the optical signals and converts the optical signals into the electric signals. To the contrary, it may be possible to configure such that the electric signal/optical signal converter 118b transmits the optical signal and the electric signal/optical signal converter 118a receives the optical signals through the connectors 11. The reception part and the transmission part may be integrally formed or separately formed in terms of circuit design. Further, the reception part and the transmission part may be also integrally formed or separately formed mechanically. With respect to the transmission portion of the optical signals including the connector portions, signals which are transmitted from the electric signal/optical signal converter 118a to the electric signal/optical signal converter 118b and signals which are transmitted from the electric signal/optical signal converter 118b to the electric signal/optical signal converter 118a to the contrary may be transmitted through separate transmission portions (in other words, two routes) or may be transmitted through the same transmission portion (in other words, one route). The signal transmission part is constituted of a semiconductor laser or, a light emitting diode or the like. The signal reception part is constituted of an optical sensor.

The transmission portions of the optical signals are formed of an optical fiber, wherein by facing end portions of the optical fibers from both boards consisting of the printed circuit board 9 and the printed circuit board 4c shown in FIG. 4 in an opposed manner at the connectors 11a, the signals can be transmitted. The connectors 11a perform the function of positioning both end portions and the dust preventing function. Further, the insertion and pulling-out force of the connectors 11a can be further decreased and hence, the setting of the biasing part 12 for pushing the tray 13 from the housing 2 at the time of ejection operation is facilitated.

Further, the connectors 11a may be configured such that the corresponding transmission part and reception part of both printed circuit boards are arranged to directly face each other thus enabling the signal transmission. In this case, a transmission portion of the optical signals can be eliminated and hence, it is possible to arrange the signal transmission part and the signal reception part to face each other in an opposed manner on the printed circuit board 9 and the printed circuit board 4c at the time of housing the tray 3. Further, in this case, provided that the transmission of signals can be performed at the transmission part and the reception part, it is unnecessary to take a distance between the transmission part and the reception part into consideration. Further, provided that the positioning of the transmission part and the reception part the prevention of dusts are not hampered, it is possible to eliminate the connector 11a for positioning and dust prevention.

Further, in performing the transmission using the optical signals, when the tray 3 and the housing 2 come close to each other to a distance which allows the transmission of the optical signals or to a distance which is necessary on design, by providing a switching function which enables the emission of light of the optical signal, the undesired power consumption can be reduced.

Further, with respect to the transmission of electric power and the transmission of signals which hardly generate drawbacks such as the deterioration of signals or the mixing of noises, also at the time of performing the signal transmission using the optical signals, both methods, that is, the method which performs the transmission of signals using the connectors and the method which performs the transmission of signals using the flexible printed cable are considered.

In this manner, with respect to the signals which are transmitted between the printed circuit board 9 and the printed circuit board 4, by adopting the optical signals as at least some signals which contain signals which are liable to generate drawbacks such as the deterioration of signals and the mixing of noises, it is possible to further reduce the mixing of noises.

This application is based upon and claims the benefit of priority of Japanese Patent Application No2003-194213 filed on Jul. 9, 2003 and Japanese Patent Application of the No2004-176828 filed on Jun. 15, 2004 the contents of which are incorporated herein by reference in its entirety.

1. An optical disc device comprising:
a first circuit part;
a holding part, on which an optical pickup capable of performing either one of recording of data and reproducing of data with respect to an optical disc is mounted; and
a second circuit part, provided to the holding part; wherein:
a distance between the first circuit part and the second circuit part is changeable;
in case that the distance between the first circuit part and the second circuit part assumes a value equal to or below a given distance, the transmission of signals containing at least analogue signals having frequency of 11 MHz or more or digital signals having a signal transmission rate of 20 Mbps or more is allowed; and
in case that the distance between the first circuit part and the second circuit part assumes a value above the given distance, the transmission of the signals is interrupted.

2. The optical disc device according to claim 1, wherein:
the optical disc device includes a pair of connectors which assume two states consisting of a contact state and a non-contact state;
a first connector of the connectors is provided to the first circuit part;
a second connector of the connectors is provided to the second circuit part; and
in case that the distance between the first circuit part and the second circuit part assumes a value equal to or below a given distance, the first connector and the second connector are brought into contact with each other so as to allow the transmission of at least one of the signals and an electric power.

3. The optical disc device according to claim 2, wherein the connectors are provided in plural pairs.

4. The optical disc device according to claim 3, wherein out of the connectors, at least one pair of connectors transmit the signals.

5. The optical disc device according to claim 1, wherein the optical disc device includes:
a first transmission part, which constantly connects the first circuit part and the second circuit part; and
a second transmission part, which allows the transmission of the signals when the distance between the first circuit part and the second circuit part assumes a value equal to or below a given distance, and does not allow the transmission of the signals when the distance between the first circuit part and the second circuit part assumes a value above the given distance.

6. The optical disc device according to claim 5, wherein:
the first transmission part transmits at least an electric power;
the second transmission part is constituted of connectors which assume two states consisting of a contact state and a non-contact state, wherein a first connector of the connectors is provided to the first circuit part and a second connector of connectors is provided to the second circuit part; and
in case that the distance between the first circuit part and the second circuit part assumes a value equal to or below a given distance, the first connector and the second connector are brought into contact with each other thus allowing the transmission of signals, and in case that the distance between the first circuit part and the second circuit part assumes a value above a given distance, the first connector and the second connector are brought into non-contact with each other thus interrupting the transmission of signals.

7. The optical disc device according to claim 1, wherein the optical disc device includes
a third transmission part, which transmits optical signals; and
a fourth transmission part, which transmits at least an electric power;
wherein the first circuit part and the second circuit part includes a conversion part which converts electric signals out of the signals into optical signals and a conversion part which converts optical signals out of the signals into electric signals respectively; and
the third transmission part is capable of transmitting the optical signals when the distance between the first circuit part and the second circuit part assumes a value equal to or below a given distance, and interrupts the transmission of the optical signals when the distance between the first circuit part and the second circuit part assumes a value above the given distance.

8. The optical disc device according to claim 7, wherein the fourth transmission part constantly connects the first circuit part and the second circuit part.

9. The optical disc device according to claim 7, wherein the third transmission part includes a light receiving element and a light emitting element and transmits the optical signals using the light receiving element and the light emitting element.

10. The optical disc device according to claim 7, wherein the optical device includes a switch part which is capable of transmitting the optical signals when the distance between the first circuit part and the second circuit part assumes a value equal to or below a given distance, and interrupts the transmission of the optical signals when the distance between the first circuit part and the second circuit part assumes a value above the given distance.

11. An optical disc device comprising:
a first circuit part;
a holding part which mounts an optical pickup capable of performing either one of recording of data and reproducing of data with respect to an optical disc; and
a second circuit part which is provided to the holding part, wherein
a distance between the first circuit part and the second circuit part is changeable, and
when the distance between the first circuit part and the second circuit part assumes a value equal to or below a given distance, a portion of the first circuit part and a portion of the second circuit part are brought into contact with each other and hence, the transmission of signals containing at least analogue signals having frequency of 11 MHz or more or digital signals having a signal transmission rate of 20 Mbps or more is allowed, and when the distance between the first circuit part and the second circuit part assumes a value larger than the given distance, the transmission of one of the analogue signals having frequency of 11 MHz or more or digital signals having a signal transmission rate of 20 Mbps or more is interrupted.

12. An optical disc device comprising:
a first circuit part;
a housing provided with the first circuit part;
a second circuit part;
a spindle motor which rotates an optical disc;
an optical pickup which approaches to or is retracted from the spindle motor and performs at least one of recording and reproducing of data with respect to the optical disc;
a tray which includes the second circuit part, the spindle motor and the optical pickup and is provided to the housing such that the tray is insertable into the housing and is removable from the housing; and
connectors which assume a contact state and a non-contact state, wherein
a first connector of the connectors is provided to the first circuit part and a second connector of the connectors is provided to the second circuit part; and
when the tray is accommodated into the housing, the first connector and the second connector are brought into contact with each other thus allowing the transmission of signals including at least one of analogue signals having a frequency of 11 MHz and digital signals of a signal transmission rate of 20 Mbps or more via the connectors.
